(19) United States
(12) Patent Application Publication
(10) Pub. No.: US 2008/0247906 A1
(43) Pub. Date: Oct. 9, 2008

(54) Luminescence Sensor for Determining and/or Monitoring an Analyte that is Contained in a Fluidic Process Medium

(75) Inventors: Camiel Heffels, Stutensee (DE); Ralf Bernhard, Stuttgart (DE); Johannes Reichert, Bruchsal (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta GmbH + Co. KG, Gerlingen (DE)

(21) Appl. No.: 11/578,519

(22) PCT Filed: Apr. 14, 2005
(86) PCT No.: PCT/EP2005/051657

§ 371 Date: Jun. 17, 2008

(30) Foreign Application Priority Data
Apr. 16, 2004 (DE) 10 2004 019 202.2
Jul. 8, 2004 (DE) 10 2004 033.3

(51) Int. Cl. G01N 21/76; B05D 5/06

(52) U.S. Cl. 422/52; 427/157

(57) ABSTRACT

A device for determining and/or monitoring an analyte contained in a fluidic process medium. The device comprises a sensor, which contains a process membrane with a porous support structure, a luminescent substance, that comes into contact with the analyte or gaseous process medium, being embedded in said support structure, an emitter unit, whose radiation excites the luminescent substance, causing it to emit luminescent radiation, a receiver unit, which detects the luminescent radiation and a control/evaluation unit, which determines the concentration or the partial pressure or pressure of the analyte using the quenching of the luminescent radiation of the luminescent substance. According to the invention, the porous support structure comprises plastic, ceramic, metal or foamed plastic.

The invention relates to a device for determining and/or monitoring an analyte contained in a fluidic process medium and includes: A sensor, which has a process membrane with a porous support structure, and a luminescent substance embedded in the support structure and coming in contact with the analyte, respectively the gaseous process medium; an emitter unit, whose radiation excites the luminescent substance to issue luminescent radiation; a receiving unit, which detects the luminescent radiation; and a control/evaluation unit, which ascertains, on the basis of quenching of the luminescent radiation of the luminescent substance, the concentration, respectively the partial pressure/pressure, of the analyte.

An optical-chemical analyte sensor, e.g. one in the form of an oxygen sensor, rests on the principle of analyte-induced, fluorescence- or luminescence-quenching of an organic dye present in a polymer matrix. Usually, the polymer-dye mixture, matched to a given analyte, is applied onto a substrate, e.g. a glass platelet or an optical fiber.

US 2003/0068827 describes an optical sensor with another type of construction. While, usually, a form-stable support layer with a luminescent, membrane-forming substance is used, this US application describes an approach in which a support matrix is embedded into the polymer-dye membrane permeable for the analyte. This approach offers two advantages compared with luminescent substance applied onto a support: On the one hand, the matrix embedded in the membrane brings about an increased scattering of the measuring radiation in the membrane and, thus, an increased luminescent radiation; on the other hand, the stability of the membrane is increased by the embedded support matrix. Moreover, the matrix is a glass-fiber filter, which is soaked with the luminescent substance. Other materials mentioned in the US application for the matrix are cellulose, cellulose acetate and nylon. For manufacture of the membrane, the support structure is immersed in the luminescent substance. Excess luminescent substance is subsequently so dried, that the luminescent substance envelopes each individual fiber with a shell. Between the individual fibers, interstices remain, in which no luminescent substance is to be found.

Additionally, it is known from U.S. Pat. No. 5,057,277 to embed the luminescent substance in silicone. For this purpose, the silicone is mixed with a filler for stability. An example of such a filler is a silicate. Then, a luminescent substance is introduced into the silicone. Here, thus, a matrix, or support structure, of silicone and a silicate is present.

An object of the invention is to provide a sensor for ascertaining the proportion of an analyte in a fluid and suitable for use in industrial measurements technology and process automation.

The object is achieved by providing the porous support structure as a plastic, ceramic, metal or foam-material. Preferably, the support structure for the process membrane is an open-pore, polytetrafluoroethylene (PTFE, e.g. Teflon PTFE) membrane.

The invention offers, compared with the known solutions, the following advantages:
The PTFE-membrane sets the thickness of the resulting process membrane, whereby the manufacture, per se, is simplified. This will be brought out more clearly in the description of the method of the invention.
The porous and flexible character of the PTFE-membrane remains partially retained, so that the finished process membrane is still flexible.
The process membrane of the invention distinguishes itself by an improved response time. As a result of the porous character of the process membrane, which remains even after introduction and drying of the dye-polymer mixture, response times, in the gas phase, of ≦200 milliseconds are obtained.
While the initially white PTFE-membrane is tinted by the introduction of the dye-polymer mixture, the membrane, nevertheless, remains diffusely scattering. As a result, it represents an almost ideal reflector. The measured amplitude signals are increased by a factor of 3-5, as compared to transparent sensor layers of similar thickness and composition.
The intensity of the measuring radiation thus can be reduced by this factor, which directly results in a corresponding improvement of the photostability of the process membrane. The good reflection characteristics of the process membrane and a possibly present collector optics matched thereto lead, as considered conservatively, to a photostability of about three months.
Evaluation is done on the basis of decay, with respect to time, of a measurement pulse, i.e. an ascertaining of the duration of luminescent radiation as a function of concentration of the analyte. Additionally, the signal parameter “amplitude”, i.e. the luminescent radiation immediately following the excitation pulse, is an indicator for estimating remaining life of the process membrane.

As already known from the state of the art, the luminescent substance involves a mixture of a dye dissolved in a first solvent and a polymer dissolved in a second solvent. In principle, all optical sensors operating on the basis of fluorescent, respectively luminescent, quenching are subject to a limited stability due to the photodegradation of the dye. The photostability depends both on the dye as well as also on the polymer being used. Thus, while the dye-class, ruthenium complexes, is, indeed, only moderately oxygen-sensitive, it does, on the other hand, possess a high photostability. Preferably used in connection with the present invention is a platinum-porphyrin complex, which is distinguished by a high sensitivity and good photostability.

For improving photostability and, thus, life expectancy of the sensor of the invention, the measuring arrangement is so embodied that the layer containing the dye is subjected to only enough measuring radiation to provide a measurement signal of sufficient quality.

For avoiding disturbance of the measurement by externally originating, stray light, a protective layer is provided, which prevents light from the process-side from getting to the process membrane. In the simplest case, the light-sealing, first protective layer has a black color and is applied on that surface of the process membrane facing toward the process. It is especially advantageous, however, when the light-blocking, first protective layer is embodied in the form of a first protective membrane. The first protective membrane is likewise formed of a support structure, i.e. a second support structure, in which a light-absorbing substance is embedded. This first protective membrane is arranged on that surface of the process membrane facing toward the process.

The protection of the process membrane by an additional, protective membrane is of great importance for the application of the sensor in abrasive media (e.g. in a clarification plant). The protective membrane is distinguished, on the one hand, by a good permeability for the analyte. This is necessary, in order that the response time for the sensor is not seriously changed; on the other hand, the protective layer must not transmit light, in order that the process membrane is, at the same time, protected from light from the environment (—> for photostability), as is the receiving unit. In the case of the receiving unit, such is preferably a photodetector, which exhibits a relatively high amplification factor for the luminescent radiation.

Alternatively or supplementally, a second protective layer is positioned in front of the first protective layer in the direction of the process medium, with this second protective layer being so embodied that the analyte can pass through it, while it blocks the liquid process medium. Preferably, this second protective layer is used, when the sensor must be sterilizable. Of interest in this connection is the fact that polystyrene withstands a large number of sterilization cycles without problem. Other suitable materials are cited in U.S. Pat. No. 6,432,363.

In order to assure unencumbered use of the sensor of the invention even under extreme process conditions, especially high pressure, additionally on the side of the process membrane facing away from the process medium, a form-stable support is provided, which permits passage of the measuring radiation of the emitter unit and the luminescent radiation detected by the receiving unit. This support is preferably secured to the process membrane.

In an advantageous form of embodiment of the device of the invention, a light-conducting rod or an optical fiber bundle is provided, on, or in, whose first end region facing away from the process the emitter unit and the receiving unit are arranged and on whose second end region is arranged the process membrane with the embedded, luminescent substance. It is to be noted that this embodiment with an emitting and receiving unit arranged in an end region of the light-conducting rod or the optical fiber bundle is not limited to the process membrane with integrated support structure described in this patent application. Naturally, it is also possible to use this arrangement of the invention for loss free conveyance of the measuring and luminescent radiation also in connection with conventional process membranes. Especially mentionable in this connection is the embodiment, wherein the luminescent substance is applied directly or indirectly on an appropriate carrier.

To assure, for example, that only the luminescent radiation falls on the receiving unit, at least one filter is arranged in the light path of the receiving unit. As required, also at least one additional filter is present in the light path of the emitter unit.

For avoiding radiation losses, the sides of the light conducting rod or the optical fiber bundle are covered, at least partially, with a reflecting layer. Preferably, the reflecting layer is formed tubularly and secured to the surface of the light-conducting rod or optical fiber bundle.

In a preferred embodiment of the device of the invention, the control/evaluation unit turns the emitter unit intermittently on, so that the measuring radiation is issued in the form of pulses. Preferably, the control/evaluation unit ascertains the concentration, respectively the partial pressure, or pressure, of the analyte in the fluid process medium over a multiplicity of pulses. The pulsed operation serves especially for increasing the life expectancy of the sensor, since the measuring radiation hitting the process membrane is less than in the case of a continuous irradiation. The intensity of the measuring radiation is, moreover, so selected, that the intensity of the luminescent radiation is sufficient for a qualitatively good measurement result.

The method of the invention for manufacturing the process membrane of the invention, respectively for manufacturing the protective membrane of the invention, includes the following method steps:
A liquid medium is applied to the porous support structure, wherein the medium involves a mixture of a polymer dissolved in a first solvent and a luminescent substance dissolved in a second solvent; in the case of the manufacture of the protective membrane, the liquid medium involves a light-absorbing substance dissolved in a first polymer;
the porous support structure is soaked through with the liquid medium;
the porous support structure is dried for a predetermined time at a predetermined supply of heat.

In detail, it is provided in an embodiment of the method of the invention that the porous support structure is clamped in a frame, the liquid medium is applied to the upper surface of the support structure, and, following a predetermined impregnation time, excess liquid medium is removed.

For the purpose of manufacturing a multiplicity of process, respectively protective, membranes of very similar properties, in an embodiment of the method of the invention, individual process membranes/protective membranes are punched, or cut, out of the dried, porous, support structure impregnated with the medium.

Then, on the surface of the process membrane facing toward the process medium, a light-blocking layer is applied.

Found to be especially advantageous has been the following alternative method for manufacture of a process membrane: The face of the process membrane facing away from the process is brought in moist condition into contact with a form-stable support transmissive for the measuring radiation and the luminescent radiation. In this way, the surface of the support facing toward the process membrane becomes wetted by the substance; then, the process membrane and the support are dried, such that the process membrane and the support become securely bonded together by the drying process.

Another alternative is to use adhesive to securely connect the process membrane with the form-stable support; following drying of the adhesive, for example, the light-blocking, protective layer is then painted onto the process membrane.

The invention will now be explained in greater detail on the basis of the drawing, the figures of which show as follows:

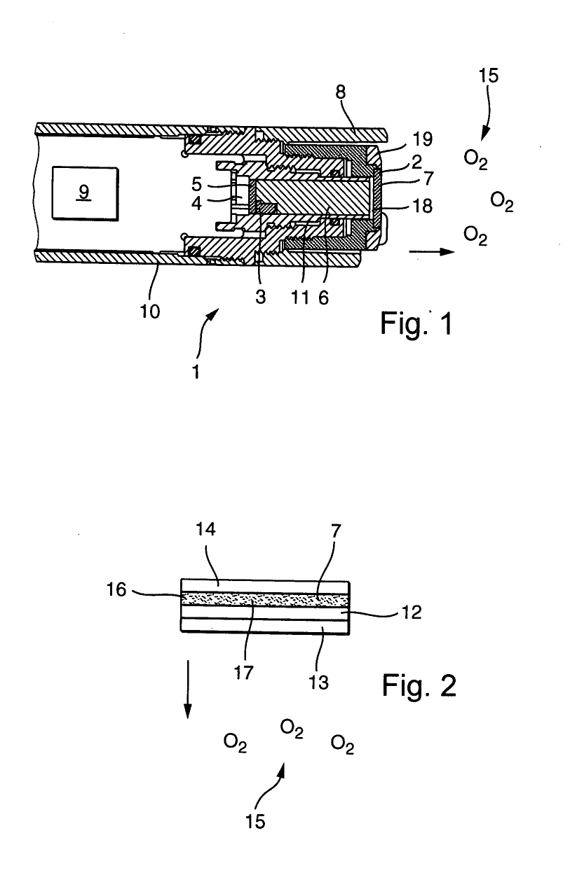

FIG. 1 a longitudinal section through a preferred embodiment of a sensor of the invention;

FIG. 2 a cross section through a preferred embodiment of the membrane 2; and

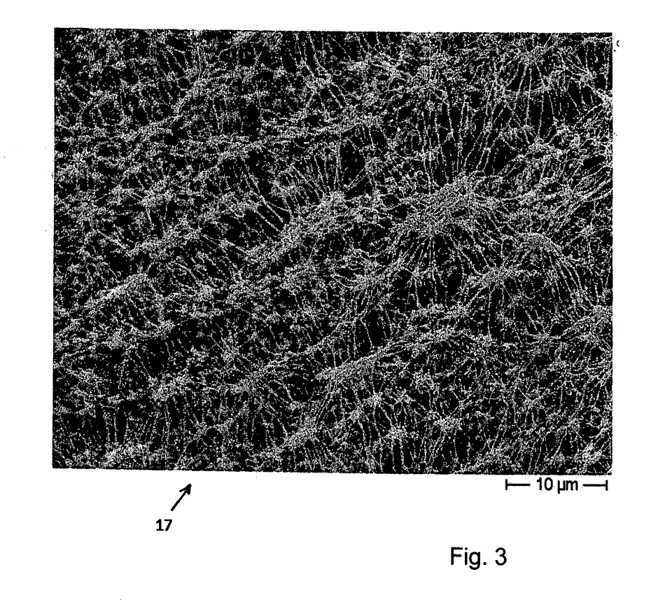

FIG. 3 an enlarged view of the PTFE-membrane used as support structure.

FIG. 1 is a longitudinal section through a preferred embodiment of a sensor of the invention 1. In particular, sensor 1 is an oxygen sensor; however, the invention is not limited to oxygen measurement. By way of example, other gaseous analytes which can be mentioned are water vapor, chlorine, nitrogen, sulfur dioxide and vaporous amines. Liquid-dissolved analytes include e.g. halogenides, metal and transition-metal ions, amino acids, nitroaromatics, sugar, and water (in oils or in gasoline).

An essential component of the sensor 1 of the invention is the process membrane 7, or the sequentially arranged membrane 2, as such is illustrated in FIG. 2. According to the invention, the process membrane 7 includes, for a support framework, a support structure 17 of plastic, ceramic, metal or foam-material. Preferably, support structure 17 is a PTFE-membrane. Such a PTFE-membrane is shown enlarged in FIG. 3. The PTFE-membrane is, as already mentioned, also best suited as support structure 17 for the first protective membrane 12.

Support structure 17 is preferably an open-pore material, since an open-pore material permits the luminescent substance 16 of dye borne in polymer to permeate unhindered throughout. Preferably, the material used for the process membrane 7 is an open-pore material, e.g. PTFE, especially Teflon PTFE, having a porosity of 50%-90%, whose pore diameter lies preferably in the range 0.1-10 μm.

The optical, electrical/electronic and functional components of the sensor 1 are arranged in a housing 10. The optical components include an emitter unit 3, a receiving unit 4, a filter 5 and a light-conducting rod 6. Emitter unit 3 is an LED, for example, while a photodiode (or a spectrometer) is used, preferably, for the receiving unit 4. Photodetector 4 has, advantageously, a relatively high amplification factor for the luminescent radiation.

Emitter unit 3 and receiving unit 4 are located in a first end region of the light-conducting rod 6, the end facing away from the process. Light-conducting rod 6 is, preferably, made of PMMA. In a second end region of the light-conducting rod 6, the end facing toward the process, one finds the process membrane 7, comprised of the luminescent substance 16 embedded in the support structure 17. Process membrane 7 is spaced from the light-conducting rod 6 by an air gap 18. This arrangement of the optical components provides a compact construction for the sensor 1 of the invention.

In order to assure that only the luminescent radiation affected by the analyte 15 falls on the receiving unit 4, at least one filter 5 is arranged in the light path to the receiving unit 4. If required, also at least one additional filter is found in the light path of the emitter unit 3.

For preventing radiation losses, the lateral surfaces of the light-conducting rod 6 or the optical fiber bundle is at least partially covered with a reflecting layer 11. Preferably, the reflecting layer 11 is embodied tubularly and secured to the outer surface of the light-conducting rod 6, respectively the optical fiber bundle.

Via the securement piece 19, process membrane 7, or, as the case may be, membrane 2, is connected with the housing 10 of the sensor 1. Also arranged in the interior of housing 10 are the electrical/electronic components of the sensor 1, especially the control/evaluation unit 9. Control/evaluation unit 9 effects, among other things, the pulse operation of the emitter unit 3, and it also evaluates the luminescent radiation of the receiving unit 4. Ascertainment of the concentration, respectively pressure/partial pressure, of the analyte 15, is done via the known methods. Especially, in the case of the sensor 1 of the invention, the evaluation is done by ascertaining and evaluating the decay time of an emitted pulse. Possible, also, however, alternatively or in combination, is to evaluate the detected luminescent radiation as regards its amplitude and/or phase. As already indicated, it is possible, for example, when evaluating the decay time of a measurement pulse, to win, from the amplitude information, information concerning the remaining life expectancy of the sensor.

FIG. 2 shows a preferred embodiment of membrane 2 in cross section. Membrane 2, as a component, is composed of four subcomponents, which are arranged sequentially in the process direction (—>) as follows: a form-stable support 14, which is of such a character that the measuring and luminescent radiation can pass through it; the process membrane 7, which is composed of a porous, support structure 17, whose pores are filled, at least partially, with the luminescent substance 16; a first protective layer 12; and a second protective layer 13.

For preventing that the measurement results are disturbed by interfering radiation penetrating from the outside, the first protective layer 12 light-seals the process membrane on the process-side. In the simplest case, the light-blocking, first protective layer 12 is a black-colored layer, which is applied to the process-facing surface of the process membrane 7. It is especially advantageous, however, when the light-blocking, first protective layer 12 is embodied as a first protective membrane. This first protective membrane 12 is, likewise, formed of a support structure 17 (for example, PTFE), in which a light-absorbing substance is embedded. This first protective membrane 12 is arranged in front of the surface of the process membrane 7 facing the process.

The protection of the process membrane 7 by a first protective membrane 12 is of great importance for the application of the sensor 1 in abrasive media (e.g. in clarification plants). The protective membrane 12 is distinguished, on the one hand, by a good permeability for the analyte 15. This is necessary, in order that the response time of the sensor 1 be not seriously affected; on the other hand, the protective layer 12 must block light, in order that the process membrane 7 be protected from environmental light (—> for photostability), as well so as the receiving unit.

Alternatively or supplementally, moreover, a second protective layer 13 is positioned in front of the first protective layer 12 in the direction of the process medium, with this second protective layer 13 being so embodied that it lets the analyte 15 pass, while blocking the liquid process medium. Preferably, this second protective layer 13 is used, when it is required that the sensor be sterilizable. Of interest in this connection is that polystyrene withstands, without problem, a multiplicity of sterilization cycles and thus is best suited as material for the second protective membrane. Other suitable materials are named in U.S. Pat. No. 6,432,363.

In order to be able to assure use, without reservations, of the sensor 1 of the invention even under extreme process conditions, especially high pressures, additionally provided on the side of the process membrane facing away from the process medium is a form-stable support 14, which is of a character such that the measuring radiation of the emitter unit 3 and the luminescent radiation detected by the receiving unit 4 can pass through it. Support 14 is preferably connected securely to the process membrane 7.

1-19. (canceled)

20. A device for determining and/or monitoring an analyte contained in a fluid process medium, comprising:
a sensor, which has a process membrane with a porous support structure, wherein a luminescent substance is embedded in the support said porous structure for contacting the analyte, respectively the gaseous process medium;
an emitter unit, whose radiation excites said luminescent substance to issue luminescent radiation;
a receiving unit, which detects the luminescent radiation; and a control/evaluation unit, which ascertains, on the basis of quenching of said luminescent radiation of the luminescent substance, concentration, respectively partial pressure/pressure, of the analyte, wherein:
said porous support structure comprises plastic, ceramic, metal or foam-material.

21. The device as claimed in claim 20, wherein:
said process membrane with said porous support structure comprises a porous PTFE-membrane.

22. The device as claimed in claim 20, wherein:
said luminescent substance comprises a mixture of a dye dissolved in a first solvent and a polymer dissolved in a second solvent.

23. The device as claimed in claim 20, further comprising:
a light-blocking, first protective layer, which light-seals said process membrane in a process direction.

24. The device as claimed in claim 23, wherein:
said light-blocking, first protective layer comprises a black paint applied to a surface of said process membrane facing in the process direction.

25. The device as claimed in claim 23, wherein:
said light-blocking, first protective layer comprises a first protective membrane, which is formed from said porous support structure, in which a light-absorbing substance is embedded, and that said first protective layer is arranged in front of a surface of said process membrane facing in the process direction.

26. The device as claimed in claim 20, further comprising:
a second protective layer, which is so embodied that the analyte can pass through it, while it blocks a liquid process medium.

27. The device as claimed in claim 20, further comprising:
in that a form-stable support, which permits radiation from said emitting unit and luminescent radiation detected by said receiving unit to pass through it and which is arranged on said process membrane.

28. The device as claimed in claim 20, further comprising:
a light-conducting rod or an optical fiber bundle, on/in whose first end region facing away from the process direction, said emitter unit and said receiving unit are arranged, and, at whose second end region facing toward the process direction, said process membrane with embedded luminescent substance is arranged.

29. The device as claimed in claim 20, further comprising:
at least one filter which is arranged in a light path of said emitter unit and/or in a light path of said receiving unit.

30. The device as claimed in claim 28, wherein:
a lateral surface of said light-conducting rod or optical fiber bundle is covered at least partially with a reflecting layer.

31. The device as claimed in claim 28, wherein:
said reflecting layer is embodied tubularly and secured on the lateral surface of said light-conducting rod, respectively optical fiber bundle.

32. The device as claimed in claim 20, wherein:
said control/evaluation unit turns said emitter unit intermittently on, so that emitter radiation is radiated in pulse-form.

33. The device as claimed in claim 20, wherein:
said control/evaluation unit ascertains concentration, respectively partial pressure/pressure, of the analyte in the fluid process medium over a plurality of pulses.

34. A method for manufacturing a process membrane for manufacturing a protective membrane, comprising the steps of:
placing liquid medium on a porous support structure, wherein the liquid medium comprises a mixture of a polymer dissolved in a first solvent and a luminescent substance dissolved in a second solvent, or the liquid medium comprises a light absorbing substance dissolved in a polymer;
soaking the porous support structure with the liquid medium; and
drying the porous structure for a predetermined time with a predetermined supply of heat.

35. The method as claimed in claim 34, further comprising the step of:
clamping the porous support structure in a frame;
placing the liquid medium on an upwardly facing surface of the support structure; and
following a predetermined time, excess liquid medium is removed.

36. The method as claimed in claim 34, wherein:
the individual process membranes are punched or cut from the dried, porous support structure impregnated with the medium.

37. The method as claimed in claim 34, wherein:
a light-blocking layer is placed on a side of the porous support structure impregnated with the luminescent substance.

38. The method as claimed in claim 34, wherein:
a surface of the process membrane facing away from the process direction is brought in moist condition into contact with a form-stable support embodied to allow passage of measuring radiation and luminescent radiation through it, a surface of the support facing toward the process membrane is wetted by the substance, and the process membrane and the support are dried, whereby the process membrane and the support are connected securely together by the drying.
